(19) United States
(12) Patent Application Publication
(10) Pub. No.: US 2004/0189637 A1
(43) Pub. Date: Sep. 30, 2004

(54) System and method for displaying well log graphics at multiple levels of resolution

(76) Inventors: Andre Abriol, Austin, TX (US); Lee B. Metrick, Austin, TX (US)

Correspondence Address: BRIGITTE ECHOLS, SCHLUMBERGER WELLS SERVICES, 200 GILLINGHAM LANE, MD-9, SUGAR LAND, TX, 77478, US

(21) Appl. No.: 10/403,835

(22) Filed: Mar. 31, 2003

(51) Int. Cl. G06T 11/20

(52) U.S. Cl. 345/440

(57) ABSTRACT

A system, a method, and a graphics user interface for displaying an indexed data set in a window on a computer display device has a pane in which indexed data is displayed at a different level of resolution from data displayed outside of the pane. The pane may be moved within the window. The window may further include at least one side pane which is used to display data at yet another level of resolution.

### TECHNICAL FIELD

This invention relates in general to the field of interpretation of well logging data, and in particular, to a method and apparatus for displaying well logging data at multiple levels of detail.

### BACKGROUND OF THE INVENTION

Accurate and rapid interpretation and evaluation of geophysical property data is a key to successful exploration and production of petroleum resources. Based on data such as electrical and nuclear properties collected in a well-bore, as well as the propagation of sound through a formation, geophysicists make an analysis useful in making many important operational decisions. The analysis includes determination of whether a well is likely to produce hydrocarbons, whether to drill additional wells in the vicinity of an existing well, and whether to abandon a well as being unproductive. Geophysicists may also use well-bore data to select where to set casing in a well and to decide on how to perforate a well to stimulate hydrocarbon flow. One method of collecting well-bore geophysical properties is by way of well logging. In well logging, a well logging tool (also often referred to as a sonde) is lowered into a well-bore on an electrical cable, the wireline. The well logging tool is an electrically powered measurement device that may, for example, collect electrical data, sonic waveforms that are propagated through the surrounding formation, or radioactivity counts. These measurements are usually converted to a digital form and transmitted on the wireline to an acquisition system.

Computer displays connected to the acquisition system enables the engineers and geologists at the well-site to make decisions with respect to further logging operations and decisions on actions to be taken to further develop production at the well. Such decisions and evaluations are also made at interpretation centers. The data collected at the well-site may be transmitted to an interpretation center operated by the logging company or to one or more offices of the client. At such interpretation centers or client offices geologists and petroleum engineers may view the collected data to make decisions relating to continued production and development of a well.

Petroleum exploration and production are extraordinarily expensive undertakings. Decisions made based on well logging data often have very significant economic impact. Often these decisions have to be made while a drilling rig is idle. It is therefore very important to have available software tools that enable the decision-makers to have the greatest possible benefit of the acquired well logging data.

In making interpretations and evaluations based on well logging data it is important to see the big picture of large sections of an oil or gas well, perhaps even the entire well. It is also important to see the detail concerning small sections of particular significance. Furthermore, the relationship of the big picture to the detail is often very important.

Well logs generally have a horizontal axis that is very short relative to its vertical axis. The vertical axis generally is borehole depth. Many well logs are indexed at 6-inch intervals. Thus, a well log of only 1000 feet would have 2000 vertical index points. The horizontal axis is usually a measured geophysical property or some value derived from the well log measurements.

The output format of a well log usually reflect the relationship of the very short horizontal axis to the very long vertical axis. For example, traditionally the well logs are paper printouts comprising very many fan-folded pages.

One technical specification of an output device is its aspect ratio. The aspect ratio is the measurement between the output width and height. For example, a standard 35 mm motion picture frame has an aspect ratio of 1.33 and an 8½×11 piece of standard paper, an aspect ratio of 0.77. The typical well log has a very small aspect ratios (often less than 0.01) whereas computer display devices usually (if not always) have aspect ratios of 1.33. One may consider well logs as “long and narrow” and computer display devices as “short and wide.”

Given the difference in aspect ratio between well logs and computer displays, it remains difficult to view a well log in its entirety on a computer display while still being able to see sufficient detail. In the prior art, the problem resulting from the incompatibility between the well log aspect ratio and computer display aspect ratio has been solved in two ways. The first is to show the entire well log on the computer display by removing detail. The other is to show as much detail as desired within a scrolling window.

Neither of those methods adequately addresses the desirable property of being able to both view a log in its entirety while still being able to see a high level of detail for any particularly significant or interesting section of the well log. Therefore, it would be desirable to have a system and method for providing simultaneous views of both a large section of a well log and high level of detail for user-selected sections of the well log.

### SUMMARY OF THE INVENTION

In a preferred embodiment, the invention provides a user interface and underlying method for driving that user interface to enable a user, for example, a log analyst or a geologist, to view an entire well log (or a large section thereof) at the same time as seeing a smaller section of the same well log at a higher level of resolution. In that preferred embodiment a pane in the log display window is used to display a section of the well log covered by that pane at a higher level of resolution than the resolution used to display other areas of the well log thereby giving the user the ability to see both the bigger picture manifested by the entire well log and the detail of a particularly interesting section of the same well log.

In a preferred embodiment of a method of displaying a well log in a window on a computer display device connected to a computer, having a window with an index axis associated along one length of the window and an index range corresponding to that index axis, a movable pane is defined in the window with a size smaller than the window along the index axis and equal in size in the other axis. The pane is moveable within the window along the index axis. The definition of a pane implicitly defines a background area not covered by the first pane. A first zone of indexed data is associated with the first pane. Having associated an index range with the first pane an index scale is calculated for the background area and the section of the index data not in the zone of data associated with the first pane is associated with the background area. Data in the zone associated with the movable pane is displayed in the movable pane using the first index scale and displaying data outside of that zone on the background area using the background index scale.

In a further embodiment, a graphics user interface is provided for manipulating the index scale of the movable pane, the location of the movable pane, the size of the movable pane, an index of the movable pane, or an index cursor associated with the movable pane. The display window is recomputed and redisplayed after such manipulation of the-movable pane. The graphics user interface may include devices selected from the set including a device for grab and drag of an index cursor, a device for moving the index cursor by steps of given distance relative to the size of the pane, a device for receiving a mouse click at a point in the window to which the user wants to move the index cursor, and a device by which the user may grab the entire window and thereby moving the index cursor. An index cursor may alternatively be moved by typing a new focus index, clicking at a desired index, or acting on user interface controls to change index forward or backward by steps. The focus index could also be manipulated from an outside source, such as another computer program, other user, other computer, or another external device. The user interface may further include a mechanism for allowing the user to alter the index scale of the movable pane by zooming the pane.

In an alternative embodiment, the user interface is further extended by having at least one side lens such the side pane does not overlapping with the first pane. A different zone of indexed data is associated with each side pane, the first pane and the background areas. In one embodiment, for each side pane there is another side pane each adjacent to the first pane and on opposite sides of the first pane from one another. In a general embodiment, there may be multiple levels of side panes. In a preferred embodiment, the index scale is the same for each side pane in a pair of side panes. The user interface of this alternative embodiment further includes one or more mechanisms for moving the lens array formed by a main lens and the side panes. If during a move, the lens array is moved so that a side lens is squeezed between the main lens and the boundary of the display area, the side lenses are adjusted.

Other aspects and advantages or the present invention will become apparent from the following detailed description, taken in conjunction with the accompanying drawings, illustrating by way of example the principles of the invention.

### BRIEF DESCRIPTION OF THE DRAWINGS

These and other features, aspects and advantages of the present invention will become better understood with regard to the following description, appended claims and accompanying drawings where:

FIG. 1 is a schematic diagram illustrating a well logging operation.

FIG. 2 is a perspective drawing of a well logging printer for producing well log hardcopy printouts.

FIG. 3 is a schematic illustration of a well log output.

FIG. 4 is a perspective drawing of a computer workstation used, for example, for viewing and manipulating geophysical data.

FIG. 5 is a schematic illustration of the prior art approach of displaying an entire well log by removing detail or by displaying more detail in a limited subsection of a well log in a scrolling window.

FIG. 6a is a schematic illustrating the relationship between a linear view of a well log data set and view of a well log data set displayed using a log lens according to one embodiment of the invention.

FIG. 6b is an alternative view of FIG. 6a showing parameter names used in formulas used to describe one embodiment of the invention.

FIG. 7a is a schematic illustrating well log data set displayed using two side lenses according to an alternative embodiment of the invention.

FIG. 7b is an alternative view of FIG. 7a showing parameter names used in formulas used to describe the alternative embodiment of the invention illustrated in FIG. 7a.

FIG. 8 is an illustrative schematic of user interface mechanisms for manipulating a log lens according to one embodiment of the invention.

FIG. 9 is a block diagram of a software system embodiment of the invention including a log lens display software module.

FIG. 10 is a high-level flow chart of the log lens display software module of FIG. 9.

FIG. 11 is a flow-chart of the process for creating a log lens.

FIG. 12 is a flow-chart of a first process for modifying a log lens.

FIG. 13 is a flow-chart of an alternative process for modifying a log lens.

FIG. 14 is a flow-chart of the process for creating a lens array having a main log lens and a pair of side lenses.

FIG. 15 is a flow-chart of a first process for modifying a lens array.

FIG. 16 is a flow-chart of an alternative process for modifying a lens array.

### DETAILED DESCRIPTION OF THE PREFERRED EMBODIMENTS

In the following detailed description and in the several figures of the drawings, like elements are identified with like reference numerals.

As shown in the drawings for purposes of illustration, the invention is embodied in a novel multiple vertical scale display system and method for displaying well log data on a computer display device. A system according to the invention provides a flexible user interface allowing a user to view some segments of a well log at a greater detail while still being able to view those segments in the context of the entire well log. Well logs are “long and skinny”. They have a very narrow aspect ratio. This aspect ratio is an artifact of the data being displayed in a well log, namely a data set that is depth indexed where the depth index can run on the order tens of thousands of feet. Computer display devices usually have aspect ratios close to 1. Even using only one pixel per depth index, it would often not be possible to display a well log in its entirety on a computer display.

For illustration purposes, the invention is described herein in terms of a depth index running in a vertical direction. This is an idealized view of well log operations. Few wells are actually drilled perfectly vertical. In fact, often wells are intentionally steered to be horizontal or even inverted. Thus, the depth index can take on the meaning of actual depth from the surface or the distance from the surface to a location. The invention is also applicable to display data that contains other index dimensions, for example, time. The invention is applicable to data sets being indexed by any quantity. Thus, the claims should not be interpreted to only cover depth indexed data although the description that follows, for exemplary purposes only, has been described primarily in terms of a vertical depth index.

The prior art has overcome the difficulty of displaying well log data on computer display devices—the difficulty of displaying a data representation that is “long and skinny” on a short and wide display device—in two ways. One method is to only show a small portion of the well log at a time. The user would scroll through the well log and display a few feet (e.g., one hundred feet) of data at a time. A drawback with that method is that the user cannot see the context of the data being displayed. Another method is to show a larger section or the entire well log, but to reduce the vertical resolution. Often it is details that are most important. For example, a well could have its best production potential in a very narrow depth band. By displaying the well log at a reduced resolution it is possible to miss or incorrectly analyze such details.

A computer system according to the invention includes a user interface that allows a user to display a well log in its entirety while yet giving a higher level of vertical resolution to a subrange. That subrange will be referred to herein as a log lens.

For illustration purposes, the invention is described herein in the context of well log display systems. However, as noted above, well logs are characteristic in that they have a depth (or time) index in one axis and a physical measurement in the other axis. The invention would be applicable to display systems for other types of indexed data and is of particular benefit where the graphical display of the indexed data favors a display with a very high aspect ratio.

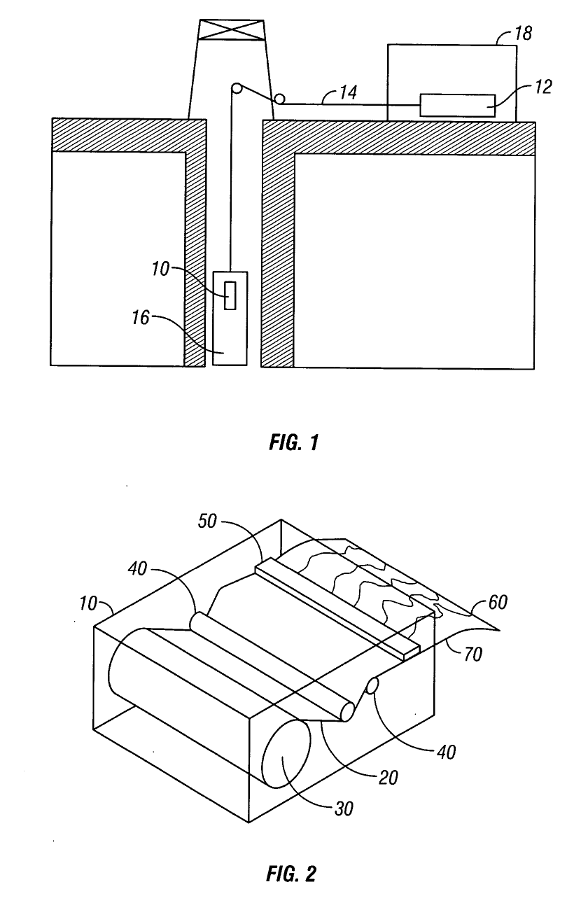

FIG. 1 is a schematic of an exemplary well log operation. An electronic instrument 16—referred to as a sonde or a logging tool (herein below, the term logging tool is used)—is lowered into a well. The logging tool 16 is suspended in the borehole of the well on a wireline 14. The uphole end of the wireline 14 is connected to a data acquisition computer 12 in a logging module 18 (e.g., a wireline well logging truck).

The wireline 14 is a collection of electrical cables for carrying instructions to the tool 16 and for carrying data transmitted from the tool 16 to the acquisition computer.

Well logs may also be obtained using other petrophysical measurement techniques. Some of these include logging while drilling, measurement while drilling, core-sampling and seismic surveying.

Thus, while FIG. 1 shows a wireline well log operation, the invention is also applicable to other operations, for example, logging while drilling (LWD), measurement while drilling (MWD), seismic operations. In fact, the invention is not limited to oil field operations but can be used with any indexed data. It has its greatest utility with data that has a narrow aspect ratio, “long and skinny”. Thus, other uses include medical data collected over an extended time interval, e.g., EKG measurements, and measurements taken with respect to long distances, e.g., flow rate in a pipeline as a function of location.

Due to the nature of well logs they tend to be very long and narrow. FIG. 2 is a perspective view of a printer 10 used for producing hard-copy well logs. Because of the long and narrow nature of well logs, the printer paper 20 used for their reproduction also is usually long and narrow, for example, spooled on a roll 30 and threaded through a feeding mechanism 40. The curves 60, depth (or other index) information, titles, etc. are printed by print heads 50 to produce log 70. While well logs may be advantageously viewed on printed out paper logs due to their aspect ratio well logs do not lend themselves to being viewed on computer display devices.

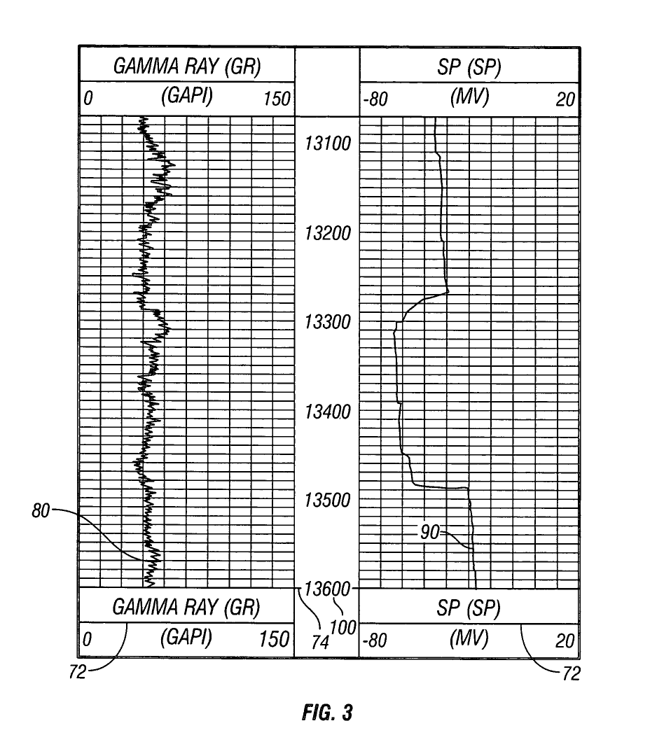

FIG. 3 is an example of a short section of a well log output. In this example, two curves of data a gamma-ray curve 80 and a spontaneous potential curve 90 are displayed next to a depth index 100. In this example, the range of data displayed is only 500 feet (from about 13100 feet to 13600 feet). Many boreholes are drilled to depths of many thousands of feet. As is evident, to be able to provide a printout that has a useful level of detail, it is necessary to print it out on either many sheets of paper or on a very long piece of paper. Herein depth usually refers to distance along the borehole from the top of the well rather than the vertical distance from the ground surface. However, the invention is equally applicable to data sets that are indexed according to the vertical distance or any other index, e.g., where the index is a function of a quantity, such as time.

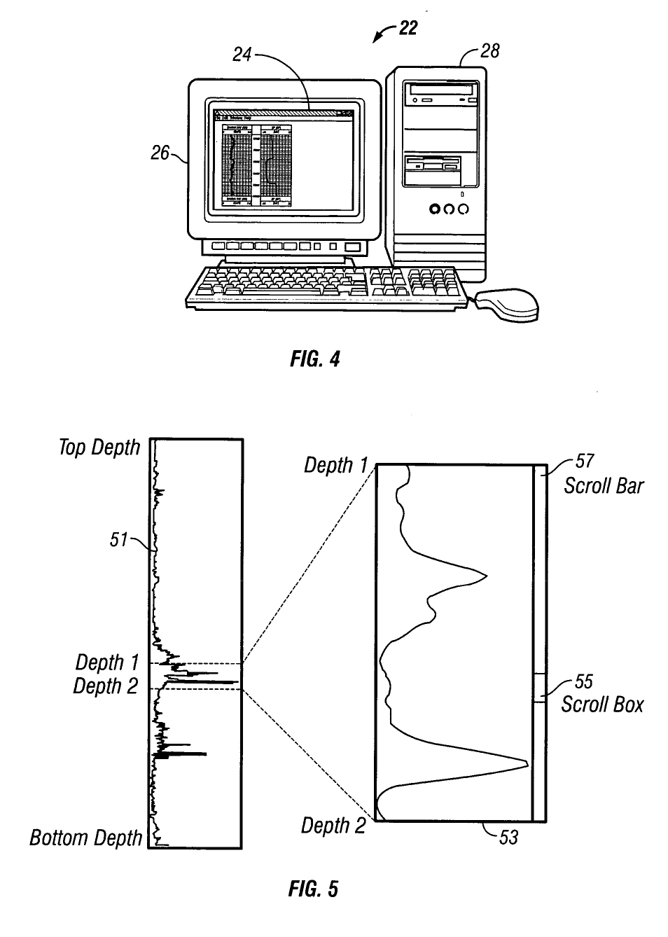

FIG. 4 is a perspective view of a computer workstation 22. The computer workstation 22 may be, for example, a component of the equipment in the well logging truck 18 or may be a log analysts workstation. The workstation consists of at least an interactive graphics display device 26 and a central processing unit 28. The computer workstation 22 may be used for viewing well logs in a window 24 on the display device 26, e.g., a CRT or a flat-panel display. However, the display 26 as an example of the dimensions of typical computer display devices is not ideal for displaying a well log in its entirety. Even very large computer display devices are not long enough in either direction for providing a suitable output medium for well log data or other “long and skinny” data representations.

FIG. 5 is an illustration of two prior art approaches to displaying well log data on a computer display device 26. Given a data set defined between two depths, Top Depth and Bottom Depth, if the distance between Top Depth and Bottom Depth is more than a few hundred feet, one would have to make a trade off between displaying the data at a lower level of detail as shown in graphic 51 or to show only a subrange of the data, as illustrated in graphic 53. In the latter case, it may be possible to scroll through the data set with a scroll box 55 in a scroll bar 57 showing which part of the data set is being displayed; the height of the scroll bar 57 represents the complete index range, the scroll box 55 height represents the index subrange being displayed on the screen, and the location of the scroll box is indicative of the position of the displayed subrange within the entire index range. The trade-off between extent and detail is an undesirable choice for a log analyst. Useful information may be found both in the detail and in the whole. Furthermore, the relationship between a section of particular interest and the rest of a well can be very valuable. As described herein, the invention overcomes the downside of having to make a trade-off between extent viewed and detail by providing a mechanism referred to herein as a log lens.

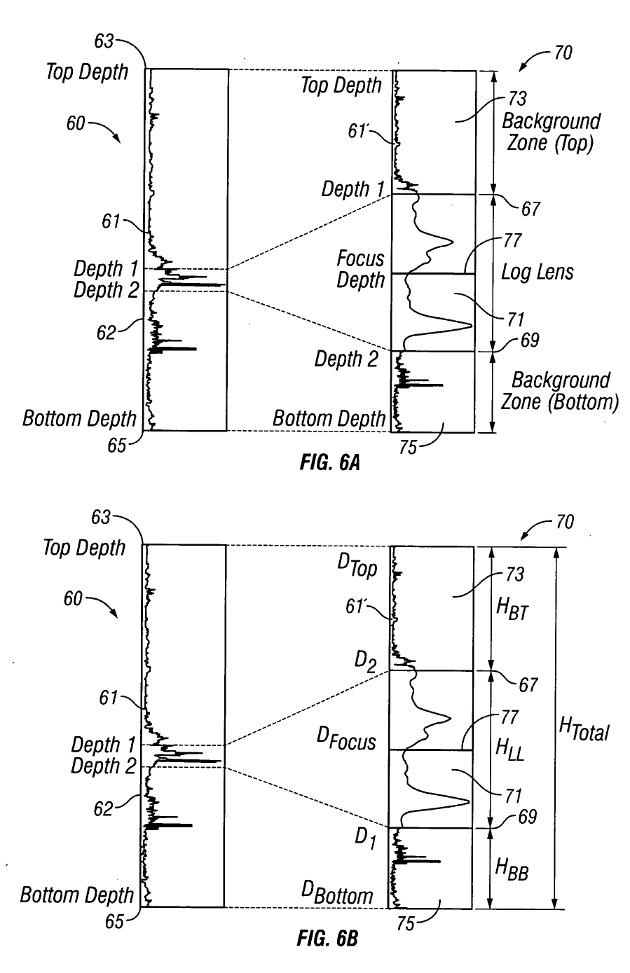

FIG. 6a is a schematic illustration of a first embodiment of the invention. As shown in graphic 60, a data set, represented by curve 61, is indexed along a vertical index axis 62 and has a range from a Top Depth 63 to a Bottom Depth 65. To display the data set on a window on a display device 26, the data is divided into three regions. An upper sub-range boundary depth 67 and a lower sub-range boundary depth 69 define the regions. The sub-range in between the sub-range boundary depths 67 and 69 is displayed in a log lens pane 71 of the display window having a different vertical scale from the vertical scale used with the other two regions. The sub-range between the boundary depths 67 and 69 is referred to herein as a log lens 71 and the sub-range above the upper boundary depth 67, as the Top Background Zone 73 and the sub-range below the lower subrange boundary depth, as the Bottom Background Zone 75. The vertical scale for the log lens 71 is selected by the user to provide a desired degree of detail for a zone of interest. The user may define the size of the log lens 71. However, in most cases the size of the log lens 71 should be selected so that there is a suitable amount space for the background zones 73 and 75.

The vertical scale for background areas may be automatically determined from the size of the background zones and the amount of data that remain to be plotted, so that the entire data set is displayed in the overall window.

For ease of manipulating a log lens 71 a focus depth 77 may be associated with the log lens 71. The focus depth 77 may be associated with some external control or used to track an externally provided depth value. For example, during a well log operation the focus depth 77 may be set to be the location of a sensor of the tool string 16.

The vertical scale is defined as follows: for a data interval spanning an index range R, plotted linearly over a plot height H, the scale is V=H/R.

FIG. 6b is an alternative view of the illustration of FIG. 6a showing various quantities used in calculating the plots of the log lens pane 71 and the background areas 73 and 75. The total height of the display window 70 is designated as H_{Total}, the height of the top 73 and bottom 75 background areas are designated as H_{BT} and H_{BB}, respectively, and the height of the log lens 71 is designated as H_{LL}. The depth associated with the top of the display is D_{Top}, the depth boundary 67 between the log lens 71 and the top background area 73 is D₂, the depth boundary 69 between the log lens 71 and the bottom background area 75 is D₁, and the depth associated with the bottom of the display window 70 is D_{Bottom}. The focus depth 77 is designated as D_{Focus}.

Assuming a given dataset, its interval (Bottom Depth 65, D_{Bottom} to Top Depth 63, D_{Top}), and a given display area (spanning vertically over a height H_{Total}), the user typically does not see the entire dataset within the log lens 71. To access other part of the dataset through the log lens, the user may change the vertical scale within the log lens 71 so more or less data fit within the log lens. Alternatively, the user may enlarge or shrink the log lens 71 to control the amount of data that fits in the log lens 71 for a given vertical scale. In another mode, the user may move the log lens 71 up or down to access other parts of the dataset.

The user may, using an interactive user interface, drag the log lens 71 up and down using a pointer such as a mouse. Alternatively, the user may control the log lens 71 in term of vertical screen position by either altering the relative heights of the top and bottom background zones so that their sum remains constant. If the log lens 71 view is updated sufficiently rapidly, the user can locate the desired data visually.

Another way of controlling the log lens 71 is in terms of index. For example, the user may specify a focus depth 77, which, typically, is the mid point of the log lens 71. One way of manipulating the location of the focus depth 77 is by simply clicking on a data feature to center it in the log lens. In other words, the clicked depth becomes the new Focus Depth.

Regardless of the manner in which the log lens 71 is moved, should the lens “hit” the bottom or top of the plot area, the log lens 71 should not move further. In this case, the focus depth 71 would no longer stay in the middle of the log lens, but instead would move towards the corresponding edge of the dataset.

In one aspect, the invention is a computer system having software for displaying a data set using a log lens 71 and software that provides a graphics user interface to a user allowing the user to manipulate the log lens as described above. The following algorithm may be used in a preferred embodiment for providing the log lens capability. For exemplary purposes depth is used as the index. However, the algorithms may readily be adapted to use other indices.

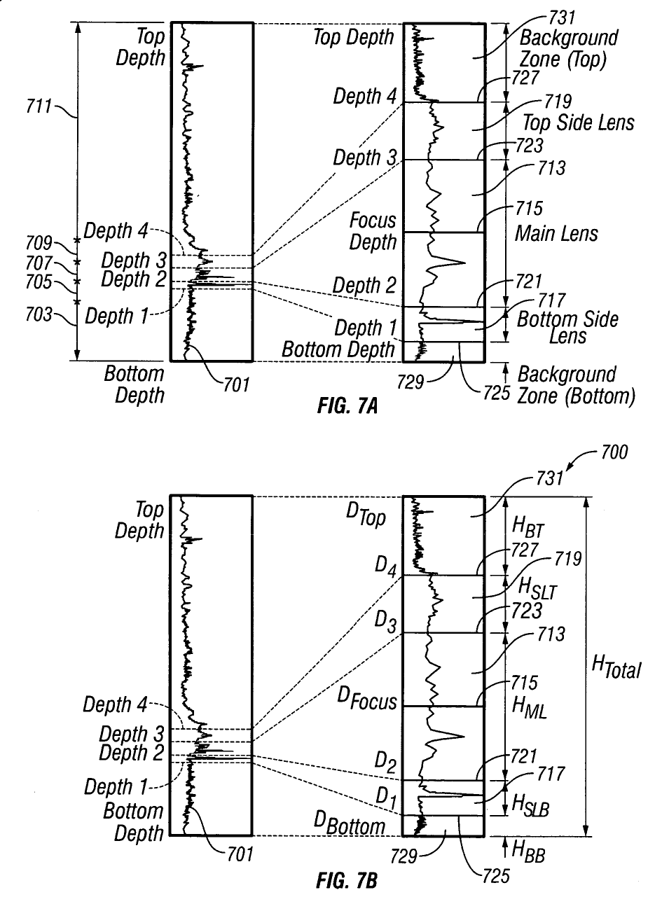

FIG. 7a is a schematic illustrating well log data set displayed using two side lenses according to an alternative embodiment of the invention. FIG. 7b is an alternative view of FIG. 7a showing parameter names used in formulas used to describe the alternative embodiment of the invention illustrated in FIG. 7a. The alternative embodiment of FIGS. 7a and 7b is described in greater detail below.

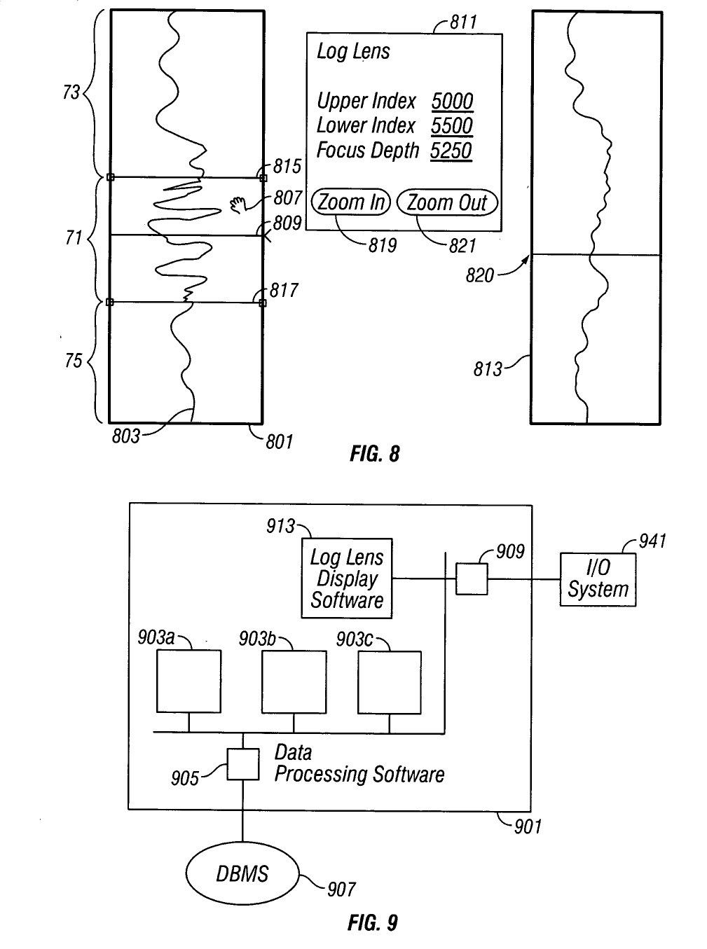

FIG. 8 is an exemplary screen layout illustrating various user interface devices that may be used to manipulate a log lens. A well log display window 801 contains one curve 803. The window 801 contains a log lens pane 71. The log lens pane 71 may be manipulated using one of several user interface devices. For example, a user may take some action that allows the user to move the log lens 71 along the index axis. For example, if the user positions the screen cursor over the log lens pane 71 and presses down on the left mouse button, that action could be taken to signify to the user interface that the user wishes to drag the pane along the index axis. To show the user that the system has accepted to move the pane, the system may change the appearance of the cursor to a small hand, as shown as element 807. Alternatively, left clicking on the log lens pane 71 could cause the boundaries and corners of the log lens pane to change appearance.

Another user interface device to manipulate the log lens pane 71 is the focus depth. An index cursor 809 indicates the focus depth of the log lens pane 71. Typically, the index cursor 809 is located in the middle of the log lens pane 71. However, that is arbitrary and in alternative embodiments the index cursor 809 is located at another location in the log lens pane 71. The user may somehow select the index cursor 809 for movement, for example, by positioning the screen cursor on it and depressing the left mouse button. With the left mouse button depressed the user is allowed to drag the focus depth to another location.

In an alternative method for manipulating the log lens the user may cause a properties dialog box 811 to pop up. One method of causing a property menu 811 to appear may be through positioning the screen cursor over the log lens pane 71 and clicking on the right mouse button. With the properties menu 811 displayed, the user may enter new values for any of the upper index, the lower index, or the focus depth.

In an alternative method of manipulating the log lens pane 71 the user merely positions the screen cursor over a new location for the index cursor 809 and clicks on that location.

In an alternative user interface for manipulating the log lens pane 71 a separate view of the entire well log in one scale is displayed in a separate window 813. An index cursor 820 may indicate the current location of the log lens pane 71. By clicking on a different portion of the window 813, the index cursor 820 is moved to that location and the index cursor 820 is moved to a corresponding location in window 801.

In an alternative method for manipulating the log lens 71, the user grabs and drags a user interface device 815 marking the upper boundary or a user interface device 817 marking the lower boundary of the log lens 71.

An alternative method for manipulating the vertical scale of the log lens 71 is to zoom in or to zoom out. The user may achieve this effect by clicking on the buttons 819 or 821.

FIG. 8 is an illustration of various user interface devices that may be used to manipulate the log lens display. Many other approaches may be used, such as scroll bars, menus to select various scales, dialog boxes that show the various log lens and background area properties, drop-down menus, etc. All such user interface devices must be considered alternatives that fall within the scope of the invention.

FIG. 9 is a schematic of a data processing software system 901 and associated system interfaces. The data processing software system 901 may be, for example, a geophysical data interpretation system or a geophysical data acquisition system. For alternative uses of the invention, the data processing software system may be a software system for manipulating data that has one long index axis one short axis, relatively speaking.

The data processing software system 901 consists of several components for providing data manipulation or analysis, e.g., 903a, 903b, and 903c. The data processing software system 901 may also contain a data retrieval and storage interface 905 for retrieving and storing data in some form of data storage, e.g., a database management system 907. The data processing software system 901 may also contain a software user interface module 909 for providing an interface to an I/O system 911. The I/O system 911 controls display of data on the display device 26.

The data processing software system 901 further consists of a log lens display software module 913. Log lens display software module 913 provides the functionality for manipulating log lenses in the graphics output displayed on the display device 26.

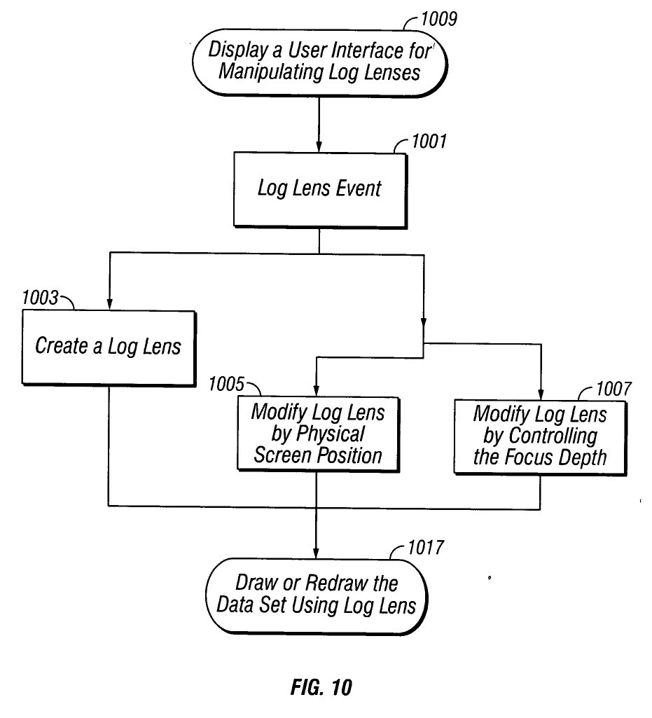

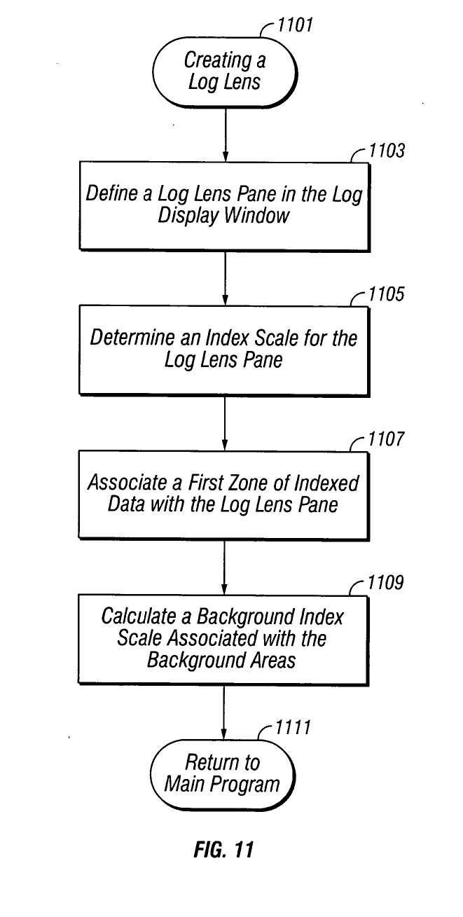

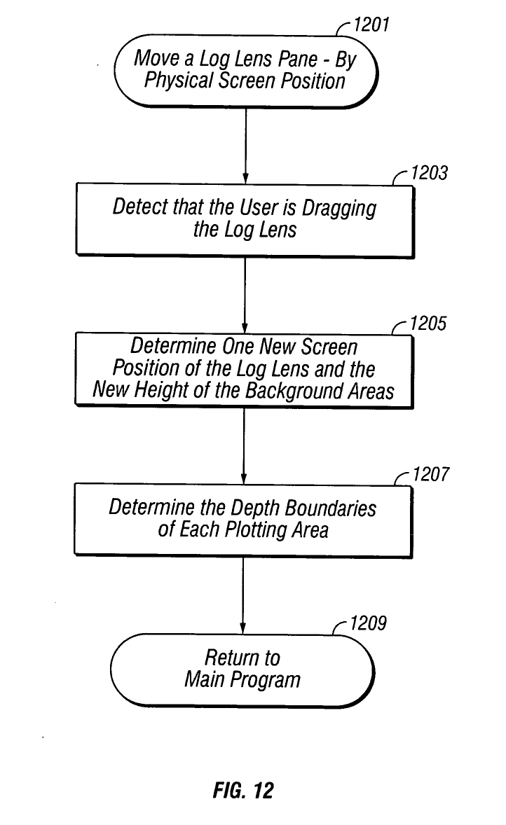

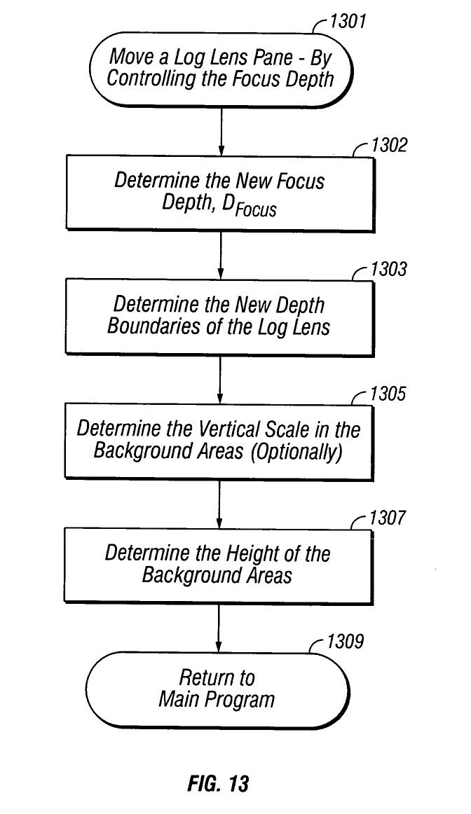

FIG. 10 is an exemplary high-level flow chart for the log lens display software module 913. As a preliminary task, the log lens display software module 913 displays a user interface, e.g., as shown in FIG. 8, for allowing a user to create and manipulate log lenses, step 1009. The log lens display software module 913 is activated by some log lens event 1001. There are two main log lens actions creating a log lens, Create A Log Lens, process 1003 and manipulating a log lens, which may be accomplished, for example, in two different ways, Modify Log Lens by Physical Screen Position, process 1005 and Modify Log Lens by controlling the focus depth, process 1007. Creation of a log lens is explained in greater detail in conjunction with FIG. 11. The processes of modifying a Log Lens are described in greater detail in conjunction with FIGS. 12 and 13.

At the conclusion of creating a log lens or manipulating a log lens, the window containing the log lens in question or the affected portion of the window is redisplayed, step 1017.

FIG. 11 is a flow chart of the process for creating a log lens, step 1003. Consider the log display window 70 of FIG. 3. The log display window 70 has associated with it an index axis along the length of the window. In a well logging embodiment of the invention, the index is usually depth, but may also be time or a function of depth or time. An index range having a higher index and a lower index is associated with the index axis. For example, in FIG. 6, a top depth 63 and a bottom depth 65 are associated with the depth index, thereby defining an index range for the window.

An event, e.g., a user interaction, triggers the start of the program flow to create a log lens, data flow 1101, in a log display window, e.g., window 24 of FIG. 4. A log lens pane is defined in the log display window, step 1103. As described below, the log lens pane is movable within the window along the index axis.

The log lens plot defines 3 plotting areas, identified from top to bottom in FIG. 6 as:

Background Top 73

Log Lens 71

Background Bottom 75

A zone of indexed data is associated with each of these plotting areas, typically so that the indexed data of one zone is only associated with one plotting area and so that no zone of data is omitted. To plot the data, the software needs to know the dimension of each plotting area as well as the depth range to plot in each area, i.e., linearly versus depth. Thus, a log lens 71 is characterized by three parameters, namely, its height, the depth range covered, and the vertical scale. Any two of these, determines the third. Providing the required information to the log lens display software 13 may be accomplished in several ways, for example:

The user chooses the dataset which defines the top index of the displayed data (D_{Top}) 63 and the bottom index of the displayed data (D_{Bottom}) 65

The user decides on the log lens 71 screen height H_{LL} (Herein, the letter D designates a data index (e.g., Depth), H designates the screen height of a plotting zone, and V designates a plotting scale.)

Next the index scale is determined, step 1105. This may be accomplished, for example, by:

The user decides on the vertical range for the log lens 71 by specifying the sub-range boundary depths (Depth 2 (D₂) 69 and Depth 1 (D₁) 67) from which the vertical scale for the Log Lens V_{LL} may be determined, by:

V_{LL}=H_{LL}/(D₁−D₂)

Alternatively, the user may specify a vertical scale for the Log Lens V_{LL}, in which case the user also positions the lens, as specified below in conjunction with FIGS. 12 and 13.

Next the log lens display software automatically adjusts the background areas both in size and vertical scale to accommodate the following constraints:

The overall plotting area is fixed

The whole dataset from D_{Bottom} to D_{Top} should fit in the overall plotting area (H_{Total}).

Thus, the vertical scale for the background area is determined from the combined height of the top background area (H_{BT}) and the height of the bottom background area (H_{BB}) as follows:

V_{B}=(H_{BT}+H_{BB})/(D_{Bottom}−D_{Top})−(D₁−D₂)

After having adjusted the background area to accommodate the insertion of the log lens 71, the log lens creation routine returns to the main program loop, step 1111, of the log lens display software, e.g., which typically would execute program code necessary to display or redisplay the data set using the log lens, step 1017 of FIG. 10.

There are two methods of positioning or repositioning the lens 71. The first of these is illustrated in the flow-chart of FIG. 12 and is based on the concept of the user dragging the log lens along the index axis. The top and bottom background areas adjust themselves accordingly.

Typically the user depressing a mouse button, moving the mouse, and subsequently releasing the button accomplishes a dragging operation. Thus, a first step is the detection of a user action to drag a log lens, step 1203. Upon the release of the mouse button, the new screen position of the log lens is determined, step 1205. Consequently, this defines the heights for the background area, H_{BT} and H_{BB} and the vertical scale of the background areas remain unchanged, namely:

V_{B}=(H_{BT}+H_{BB})/(D_{Bottom}−D_{Top})−(D₁−D₂)

Next, the depth boundaries of each plotting area is determined, step 1207, by:

D_{Top} (already known from the user selection of the data set to display)

D₂=D_{Top}+H_{BT}/V_{B}

D₁=D₂+H_{LL}/V_{LL}

D_{Bottom} (already known from the user selection of the data set to display)

At this stage, the software has all the parameters necessary to draw each plotting area using plotting software. Therefore, the process of moving a log lens pane by dragging the log lens returns control to the main log display software, step 1209, which redraws the log display, step 1017 of FIG. 10.

FIG. 13 is a flow-chart illustrating an alternative method of moving a log lens 71. In this alternative the user decides on a new focus depth, D_{Focus}, and the log display software 913 positions the log lens around the new focus depth 77 so that the focus depth is centered in the log lens. The schematic of FIG. 6 illustrates a focus depth 77 centered in the log lens 71. First, a new focus depth, D_{Focus}, is determined, step 1302. As discussed in conjunction with FIG. 8, the user can indicate the new focus depth in one of several ways, e.g., by entering a numerical value in a field, or interactively clicking on a feature picked anywhere on the plot.

The log lens display software 913 next determines the depth boundaries of the log lens, step 1303, as follows:

D₁=D_{Focus}+((H_{LL}/2)/V_{LL})

D₂=D_{Focus}−((H_{LL}/2)/V_{LL})

Next, step 1305, the log display software 913 determines the vertical scale in the background areas, V_{B} (V_{B} should remain unchanged. However, due to rounding errors, it is often useful to recalculate it.):

Total Background height=H_{Total}−H_{LL}

Total Background Range=(D_{Bottom}−D_{Top})−(D₁−D₂)

V_{B}=Total Background height/Total Background Range

Finally, step 1307 the software determines the height of the background areas:

H_{BT}=(D₂−D_{Top})*V_{B}

H_{BB}=(D_{Bottom}−D₁)*V_{B}

At this stage, the software has all the parameters necessary to draw each plotting area using plotting software and consequently returns, step 1309, control to the main program of the log lens display software.

The user may also perform other manipulations to a log lens. For example, a user may, using user interface devices such as dialog box 811, by dragging a plotting area boundary 815 or 817, zooming the log lens, cause a change in the scale of the log lens. After any such manipulation, the depth boundaries defining the range of data associated with the log lens and the background areas are recomputed and the data set is redisplayed with the new values.

In an alternative embodiment additional log lenses, known as side lenses, are added to the display adjacent to the main log lens. This arrangement is illustrated in FIG. 7a. A data set 701 is divided up into five zones—as opposed to three, as described above in conjunction with FIG. 6, zones 703, 705, 707, 709, and 711. Each zone has associated with it one index range of data. The central zone 707 corresponds to a main log lens 713. As with the previous example, a focus depth 715 may be associated with the main log lens 713. Positioned adjacent to the log lens 713, and on opposite sides there of, are located two side lenses, namely, a bottom side lens 717 and a top side lens 719.

FIG. 7b is an alternative view of FIG. 7a showing parameter names used in formulas used to describe the alternative embodiment of the invention illustrated in FIG. 7a, as follows:

Htotal—the total height of the display area 700

HBT—the height of the top background area 731

HSLT—the height of the top side lens 719

HML—the height of the main log lens 713

HSLB—the height of the bottom side lens 717

HBB—the height of the bottom background area 729

DTop—the depth at the top of the display area

D4—the depth at the boundary 727 between the top backround area 731 and the top side lens 719

D3—the depth at the boundary 723 between the top side lens 719 and the main log lens 713

DFocus—the depth at the index cursor

D2—the depth at the boundary 721 between the main log lens 713 and the bottom side lens 717

D1—the depth at the boundary 725 between the bottom side lens 717 and the bottom background area 729.

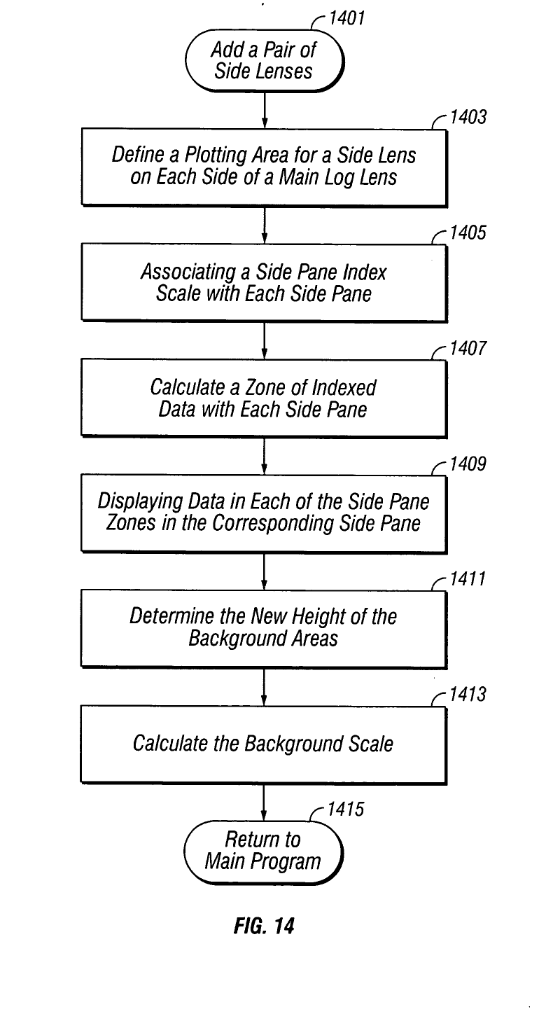

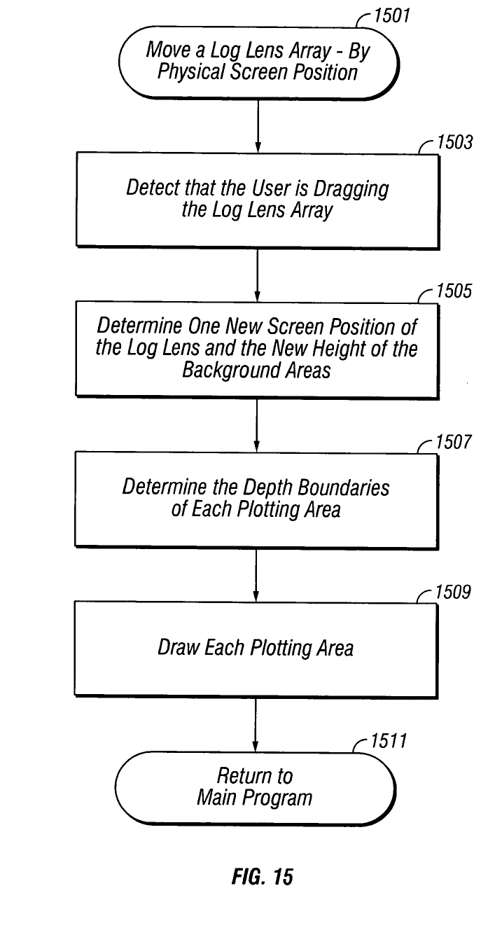

FIG. 14 is a flow chart illustrating the software process 1401 of including side lenses in a log display window. First, a plotting area is defined on each side of a main log lens 713, step 1403, i.e., the height of each side lens is defined.

Next the user defines a vertical index scale, V_{SL}, for side lenses, step 1405. The log lens display software may offer a default value for the vertical index scale, V_{SL}.

Next a zone of data is associated with each such plotting area is calculated, step 1407. Given the values D3 and D2 defining the data zone for the main log lens, D4 and D1 may be determined as follows:

D4=D3−H_{SLT}/V_{SL}

D1=D2+H_{SLB}/V_{SL}

Certain values of H_{SLB} or V_{SL} could result in the depth D4 having an impossible value, e.g., a depth value above D_{Top}. Similarly, it is possible that some values of H_{SLT} or V_{SL} could result in the depth D1 being impossible, e.g., below DBottom. To avoid such anomalous results, the log lens display software would impose constraints to the user on the values of H_{SLB}, H_{SLT}, and V_{SL}.

Alternatively, the user could define the depths for the side lenses and the vertical scale could be computed, in which case the log lens display software would impose constraints to the user's choice of depths so that the both side lenses would have the same scale. In another alternative, the user could define both the vertical scale and the depths, from which the respective heights of the side lenses would be determined.

When the side lenses have been defined, the data set may be plotted so that data corresponding to each side lens is plotted in that side lens according to the side lens index scale, V_{SL}, step 1409.

Having introduced the side lenses 717 and 719, the log lens display software 913 calculates the height of the background areas, step 1411, and the background index scales, 1413, and returns to the main program so that the display can be redrawn, step 1415.

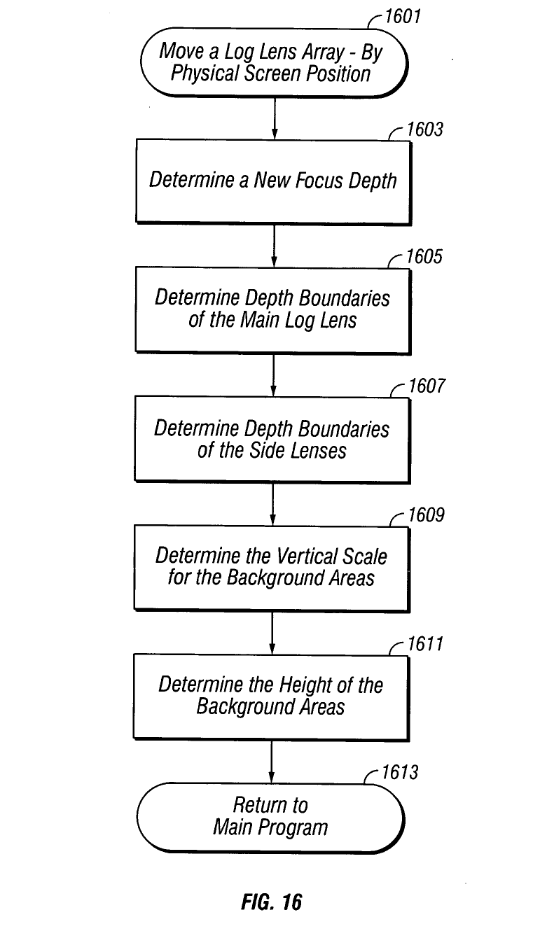

FIG. 15 and 16 are flow charts of two alternative approaches for positioning a lens array having a main lens and a pair of side lenses. In both cases, the background areas 729 and 731 are automatically adjusted in size to accommodate the constraints that the overall plotting area does not change with the movement of the lens array and that the whole data set should fit in the overall plotting area.

FIG. 15 is a flow chart of a software process for allowing the user to position the log lens array by dragging the array with the mouse cursor to a new location. Thus, as a first step the process detects that the log lens array is being dragged by the user, step 1503. When the user indicates the new position by dragging the log lens array at a new location, a new location is determined and the background plotting areas are automatically adjusted, step 1505. The lens array does not change height during a move operation. However, the background height, H_{BT} and H_{BB}, are adjusted by the same amount as the movement of the lens array, e.g., if the lens array moves up 100 pixels, H_{BT} is reduced by 100 pixels and H_{BB} is increased by 100 pixels.

The vertical scale of the background areas, V_{B}, remains unchanged as follows:

Overall Lens Range=((H_{SLT}+H_{SLB})/V_{SL})+(H_{ML}/V_{ML})

V_{B}=(H_{BT}+H_{BB})/(D_{Bottom}−D_{Top}−Overall Lens Range)

Next the depth boundaries for each plotting area is determined, step 1507, by:

D_{Top} (unchanged by movement of lens array)

D₄=D_{Top}+H_{BT}/V_{B}

D₃=D₄+H_{SLT}/V_{SL}

D₂=D₃+H_{ML}/V_{ML}

D₁=D₂+H_{SLB}/V_{SL}

D_{Bottom} (unchanged by movement of lens array)

One manner in moving the lens array is by dragging the main log lens. If the main log lens is moved closer to the upper or lower boundary of the display window, it may squeeze out the side lens between that boundary and the main log lens. Under that situation H_{SLT} and H_{SLB} are adjusted so that their sum remains constant while allowing the main log lens to move closer to the boundary. For example, if before the move H_{SLT}=H_{SLB}=k and the main log lens is moved to m units from the top of the display window (where the units may be pixels) and m<k, then after the move H_{SLT}=m and H_{SLB}=k+(k−m). In a preferred embodiment, the main log lens cannot move beyond the boundary of the display window. Thus, at the extreme both the both the background area and the side lens between the main log lens and the boundary disappear, i.e., if the main log lens is moved up to the top of the display window, H_{BT}=H_{SLT}=0.

From step 1507 all necessary information to draw each plotting area is known. Thus, the next step is to render the display window by drawing each plotting area, step 1509. Having rendered the display window, the process returns to the main program, step 1511.

FIG. 16 is a flow-chart of an alternative method of positioning a log lens array, namely, by controlling the focus depth 715. In this alternative the user decides on a new focus depth, D_{Focus}, and the log display software 913 centers the log lens array around it. The schematic of FIG. 7 illustrates a focus depth 715 centered in the main log lens 713. First, a new focus depth, D_{Focus}, is determined, step 1603. As discussed in conjunction with FIG. 8, the user can indicate the new focus depth in one of several ways, e.g., by entering a numerical value in a field, or interactively clicking on a feature picked anywhere on the plot. The new focus depth can also be obtained from an external source, e.g., when the focus depth is linked to the position of a logging tool in an oil well.

The log lens display software 913 next determines the depth boundaries of the main log lens, step 1605, as follows:

D₂=D_{Focus}+((H_{ML}/2)/V_{ML})

D₃=D_{Focus}−((H_{ML}/2)/V_{ML})

These formulas presume that there is room for ½ the main log lens 713 between the focus depth 715 and the boundary of the display area, i.e., that:

D_{Focus}+((H_{ML}/2)/V_{ML}≦D_{Bottom}; and

D_{Focus}−((H_{ML}/2)/V_{ML}≧D_{Top}

If either of these conditions does not hold, D_{FOCUS} is allowed to float within the main log lens 713 and D2 and D3 are set as follows:

If D_{Focus}+((H_{ML}/2)/V_{ML}>D_{Bottom}, D₂=D_{Bottom} and D₃=D₂−H_{ML}/V_{ML}

If D_{Focus}−((H_{ML}/2)/V_{ML}<D_{Top}, D₃=D_{Top} and D₂=D₃+H_{ML}/V_{ML}

Next, the log lens display software 913 determines the depth boundaries for the side lenses as follows, step 1607:

D₄=D₃−H_{SLT}/V_{SL}

D₁=D₂+H_{SLB}/V_{SL}

Next, the log lens display software 913 determines the vertical scale for the background areas, V_{B}, step 1609:

Total Background Height=H_{Total}−H_{SLT}−H_{ML}−H_{SLB}

Total Background Range=(D_{Bottom}−D_{Top})−(D₁−D₄)

V_{B}=Total Background Height/Total Background Range

Finally, the log lens display software 913 determines the height of the background areas, step 1611:

H_{BT}=(D₄−D_{Top})*V_{B}

H_{BB}=(D_{Bottom}−D₁)*V_{B}

At this stage, the software has all the parameters necessary to draw each plotting area using a plotting software and consequently returns, step 1613, control to the main program loop of the log lens display software.

The concept of side lenses as described above in conjunction with FIGS. 14, 15, and 16 has for exemplary purposes been limited to one level of side lenses. However, it would be possible to extend the invention so that multiple levels of side lenses are applied such that, for example, each of the side lenses 719 and 717 in FIG. 14 have an additional side lens between it and the background area. There is no theoretical limit on how many nested pairs of side lenses are employed. However, for practical reasons, it may be desirable to not use more than one or two levels of side lenses.

The foregoing describes preferred embodiments of the invention and is given by way of example only. In particular, the invention has been described using well log data for the examples herein. The invention is not limited to well log data but is applicable in many other domains. Similarly, the index used herein has, for exemplary purposes, been depth. Any other appropriate index may be used. Furthermore, the invention has been described in the context of vertical data. The invention would be equally applicable to data that is not vertical. For example, in the oil and gas exploration domain, many wells are drilled at an angle or horizontally; virtually without exception the angle of the well is not constant. Therefore, it may be convenient to view data using an index other than depth, e.g., distance from the well-head.

The invention is not limited to any of the specific features described herein, but includes all variations thereof within the scope of the appended claims.

What is claimed is:

1. A method of displaying an indexed data set in a window on a computer display device connected to a computer, comprising:
associating an index axis along one length of the window;
associating an index range having an higher index and a lower index along the index axis;
defining a first pane in the window with a size smaller than the window along the index axis and equal in size in the other axis, moveable within the window along the index axis, and a first index scale thereby implicitly defining a background area not covered by the first pane;
associating a first zone of indexed data with the first pane;
calculating a background index scale associated with the background area and having an associated background range of index values;
displaying data in the first zone on the first pane using the first index scale and displaying data outside of the first zone on the background area using the background index scale.

2. The method of claim 1, wherein the background range of index values does not contain index values in the first zone.

3. The method of claim 1, further comprising:
presenting a graphics user interface for manipulating the index scale of the first pane.

4. The method of claim 1, further comprising:
presenting a graphics user interface for manipulating at least one parameter of the first window selected from: the position of the first pane along the index axis, the size of the first pane along the index axis, the higher index of the pane, and the lower index of the pane thereby changing the data associated with the first zone; and
redisplaying the data associated with the first zone in the first pane according to such manipulated parameter

5. The method of claim 4, further comprising in response to the manipulation of a parameter of the first pane, recomputing the background index scale and redisplaying data outside the first zone in the background area.

6. The method of claim 1, comprising:
associating an index cursor with a pane corresponding to a focus index of the data, and associating a preferred physical position for the index cursor relative to the pane.

7. The method of claim 6, further comprising:
responsive to receiving an indication from the user indicative of a move of the index cursor:
calculating the focus index corresponding to the new index cursor position;
repositioning the pane so that the preferred position of the index cursor relative to the pane is preserved, if doing so would not place the pane partially outside the window else restricting the movement of the pane so that it remains within the window, thereby no longer preserving the preferred cursor position relative to the pane; and
re-displaying the data according to the new pane position.

8. The method of claim 5, further comprising presenting to the user a user interface device is selected from:
a device for grabbing and dragging the index cursor along the index axis;
user interface controls to move the index cursor by steps of given distance on the screen or a distance relative to the size of the pane;
a device for receiving a mouse click at a point in the window to which the user wants to move the index cursor; and
a device enabling the user to grab the entire pane and dragging the entire pane to a new location and thereby moving the index cursor so that the preferred cursor position relative to the pane is preserved.

9. The method of claim 7, further comprising:
obtaining a new focus index for the cursor and repositioning the cursor accordingly.

10. The method of claim 9, wherein the focus index is obtained by an action selected from:
the user typing a new focus index;
the user clicking at a chosen index in the window and the new focus index assuming the value of the index where clicked; and
acting on user interface controls to change the focus index forward or backward by steps, such as an absolute change in index, or a change relative to the range covered by the pane containing the index cursor, such as half the range.

11. The method of claim 9, wherein obtaining new focus index for the index cursor is selected from:
obtaining a new value for the focus index for the cursor is selected from:
obtaining the focus index from an external source selected from being provided by another program in the host computer and the user interacting with this another program; and
obtained from a remote user, program, computer or device.

12. The method of claim 6, further comprising:
providing a mechanism for the user to change the preferred cursor position relative to the pane selected from:
enabling the user to grab the cursor and drag the cursor to a new position within the pane;
enabling the user to type a value representing the preferred cursor position relative to the pane; and
enabling the user to select between a plurality of preset alternative preferred cursor positions.

13. The method of claim 4, further comprising:
providing a user interface window showing the location of the focus index with respect to a portion of the well log;
providing a second user interface window displaying a larger extent of the well log and location of the focus index in the larger extent of the well log; and
adjusting the focus index according to a user indicating a new focus index by user manipulation of the index cursor in the second user interface window; and
re-displaying the data according to the adjusted focus index.

14. The method of claim 4, comprising:
providing a graphics user interface device for allowing a user to change the scale of a pane;
changing the scale according to a user indicating a change in scale;
re-displaying the data according to the changed scale.

15. The method of claim 14, wherein the device for allowing a user to change the scale of a pane is selected from the set including:
a data entry input box into which a new scale may be typed;
a data entry input box into which the index range corresponding to the pane may be typed;
a mechanism for zooming the pane to a user specified scale; and
a mechanism for zooming the pane to one of a plurality of preset alternative preferred scales.

16. The method of claim 1, wherein the method further comprises:
defining at least one side pane in the window and not overlapping with the first pane;
associating a side pane zone of index data with each side pane;
associating a side pane index scale with each at least one side pane;
displaying data in each side pane zone in the associated at least one side pane.

17. The method of claim 16, wherein the method further comprises:
aligning the at least one side pane immediately adjacent to the first pane so that the first zone and the at least one side pane zone are adjacent to one another.

18. The method of claim 17, wherein the at least one side pane is a pair of side panes with each member of the pair located adjacent to the first pane and opposite the other member relative to the first pane.

19. The method of claim 18, wherein the first pane is a primary pane, each side pane is a secondary pane and further comprising at least one pair of n-ary panes wherein each member of each at least one pair of n-ary panes is located adjacent to a member of an (n−1)-ary pane pair and opposite to the (n−2)-ary pane also adjacent to the (n−1)-ary pane and the other member of the n-ary pane pair is located adjacent to the other member of the (n−1)-ary pane pair and opposite to the (n−2)-ary pane also adjacent to the (n−1)-ary pane, wherein n is greater than 1.

20. The method of claim 18, further comprising:
assigning a first side pane index scale to the first side pane and a second side pane index scale to the second side wherein first side pane index scale and the second side pane index scale are equal pane.

21. The method of claim 17, comprising:
in response to an external action, adjusting at least one parameter of the first pane selected from: the first index scale, the location of the first pane, the zone corresponding to the first pane, the focus index for the first pane;
adjusting each side pane index range in response to such adjustment to maintain each side pane adjacent to the first pane thereby changing the data associated with each of the first zone and side pane zone; and
adjusting the background index range in response to such adjustment of at least one parameter of the first pane.

22. The method of claim 21, wherein the step of adjusting each side pane further comprises:
in response to an adjustment of the first pane that places the first pane too close to one side of the window to allow the full side pane to fit in between the first pane and said higher or lower index, reducing the size of the side pane along the index axis just enough to fit and adjusting the side pane index range accordingly so as to maintain the side pane index scale unchanged.

23. The method of claim 22, wherein there are two side panes each located adjacent to the first pane on opposite sides thereof such that a first side pane is located between the first pane and said one side of the window and a second side pane is located opposite the first pane and wherein the steps of adjusting the size and range of the side pane further comprises:
decreasing the size of the first side pane along the index axis by an amount l (length) where l is the minimum amount by which the first side pane must decrease in size to fit between the first pane and said one side of the window;
changing the index range of the first side pane so that the index scale of the first side pane remains unchanged;
increasing the size of the second side pane along the index axis by l, and changing the index range of the second side pane so that the index scale of the second side pane remains constant; and
thereby maintaining the total index range of the first side pane and the second side pane unchanged, and the index range associated to the background area unchanged.

24. The method of claim 21, wherein the external action is selected from the set including a user action and the manipulation of the focus index by an external process.

25. The method of claim 21, further comprising in response to the adjustment of one parameter of the first pane: redisplaying the data associated with the first zone in the first pane, redisplaying the data associated with each side pane zone with the associated side pane, and redisplaying the data not associated with either the first pane or a side pane in the background area.

26. The method of claim 16, wherein the at least one side pane index scale is in between the first index scale and the background index scale.

27. A display software system for displaying an indexed data set on a computer display device having a window for displaying the indexed data set wherein the window is indexed along one axis, comprising:
a logic means for creating a pane in the window thereby implicitly defining at least one background area not covered by the pane;
a logic means for defining a first index scale for the pane and a background index scale for the background area;
a logic means for associating a first zone of data with the pane and all other data with the at least one background area;
a logic means for displaying the data in the first zone of data in the pane at the first index scale and for displaying data not in the first zone of data in the at least one background area at the background index scale.

28. The display software system of claim 27, further comprising:
a graphics user interface for manipulating at least one parameter of the first window selected from: the position of the first pane along the index axis, the size of the first pane along the index axis, the higher index of the pane, and the lower index of the pane thereby changing the data associated with the first zone.

29. The display software of claim 27, further comprising:
a logic means for associating an index cursor with a pane created with the logic means for creating a pane;
a graphics user interface device operable to accept an input from a user to move the index cursor; and
a logic means operable to move the pane in response to an indication to move the index cursor from the user via the graphics user interface device.

30. The display software of claim 29, wherein the graphics user interface device is selected from:
a device for grabbing and dragging the index cursor along the index axis;
user interface controls to move the index cursor by steps of given distance on the screen or a distance relative to the size of the pane;
a device for receiving a mouse click at a point in the window to which the user wants to move the index cursor; and
a device enabling the user to grab the entire pane and dragging the entire pane to a new location and thereby moving the index cursor so that the preferred cursor position relative to the pane is preserved.

31. The display software of claim 29, further comprising:
a logic means for obtaining a new focus index for the index cursor and repositioning the cursor accordingly, wherein the logic means for obtaining a new focus index is selected from:
a device allowing the user to type a new focus index;
a device allowing the user to click at a chosen index in the window;
a device for allowing the user to change the focus index by forward or backward steps, such as an absolute change in index, or a change relative to the range covered by the pane containing the index cursor, such as half the range.

32. The display software of claim 27, further comprising:
a logic means for defining at least one side pane in a window having a first pane and not overlapping the first pane and having an index scale and corresponding to a zone of indexed data different from the first pane.

33. A graphics user interface for viewing indexed data, comprising:
a window;
a pane in the window having associated therewith a first index scale;
a background area having associated therewith a second index scale;
wherein a first set of indexed data is displayed in the pane according to the first index scale and a second set of data is displayed in the background area according to the second index scale.

34. The graphics user interface of claim 33, further comprising:
at least one graphics interface device for indicating a desired movement of the pane.

35. The graphics user interface of claim 33, further comprising:
a graphics user interface device for changing the first index scale.

36. The graphics user interface of claim 33, further comprising:
a side pane adjacent to the pane and having associated therewith a second index scale; wherein a third set of data is displayed in the side pane.
